(19) United States
(12) Patent Application Publication
(10) Pub. No.: US 2015/0347949 A1
(43) Pub. Date: Dec. 3, 2015

(54) MEASURING PROFICIENCY AND EFFICIENCY OF A SECURITY OPERATIONS CENTER

(71) Applicant: International Business Machines Corporation, Armonk, NY (US)

(72) Inventors: Paul J. Dwyer, Pewaukee, WI (US); Cory A. Mazzola, Henderson, NV (US); David M. McGinnis, Roswell, GA (US)

(73) Assignee: International Business Machines Corporation, Armonk, NY (US)

(21) Appl. No.: 14/287,643

(22) Filed: May 27, 2014

(51) Int. Cl. G06Q 10/06

(52) U.S. Cl. CPC G06Q 10/06393

(57) ABSTRACT

A method and associated systems for measuring proficiency and efficiency of a security operations center. A processor gathers statistical information that identifies characteristics of a security-operations centers performance of a process during a certain period of time. The processor uses this information to derive values of a set of empirical metrics, and then uses these metric values to derive a set of novel parameters. These parameters quantize characteristics of the organization's proficiency and efficiency when servicing incoming service requests associated with the process. These parameters may also be used to identify proficiency or efficiency standards associated with the organization's past performance and to identify target standards that allow measurement of the organization's current or future performance.

### TECHNICAL FIELD

The present invention relates to measuring performance characteristics of a Security Operations Center (SOC) or other service-provider organization that must respond to incoming service requests or other events.

### STATEMENT REGARDING PRIOR DISCLOSURES BY THE INVENTOR OR A JOINT INVENTOR

The following disclosure(s) are submitted under 35 U.S.C. 102(b)(1)(A):

1. IBM Security SOC Process Capability Analysis Discussion Guide
SOC Ops Method—Operations Management Metrics.PPT
(PowerPoint Presentation, Jun. 3, 2013, abridged)
Paul Dwyer, author

Publicly presented on:
Jun. 5, 2013 (presented to Royal Bank of Canada, Toronto CANADA)
Sep. 18, 2013 (presented to Liberty Mutual, Portsmouth, N.H.)
Nov. 14, 2013 (presented to Lloyds Banking Group, Edinburgh, Scotland))
Feb. 13, 2014 (presented to Royal Bank of Scotland, Edinburgh, Scotland))
Apr. 24, 2014 (presented to Scotia Bank, Toronto CANADA)

2. IBM Security SOC Process Capability Analysis Discussion Guide
SOC Ops Method—Operations Management Metrics v2.PPT
(PowerPoint Presentation, Jun. 3, 2013, unabridged)
Paul Dwyer, author

Publicly presented on:
Jan. 22, 2014 (presented to Royal Bank of Canada, Toronto CANADA)

### BACKGROUND

It may be difficult to monitor and manage throughput, efficiency, effectiveness and other performance indicators of a business function that must respond to ad hoc extrinsic events, such as a Security Operations Center, a customer-service operation, or a technical help desk.

Such a management or control mechanism would have to be responsive, scalable, sustainable, and cost-effective, and would have to maintain high levels of accuracy and reliability in an environment wherein a workload spike may be triggered without warning by an unexpected security threat or service outage.

There are currently no such management frameworks that can dynamically identify and maintain work standards based on real-world data and use those standards to measure proficiency, efficiency, and other performance indicators of an SOC or similar service-provider operation.

### BRIEF SUMMARY

A first embodiment of the present invention provides a method for measuring proficiency and efficiency of a security operations center, wherein the security operations center performs a plurality of processes, the method comprising:

a processor of a computer system receiving information about the security operations center's prior performance during a standard time period of a first process p of the plurality of processes;

the processor interpreting the received information to generate a plurality of values of one or more empirical metrics, wherein a first subset of the plurality of values comprises values of a first metric of the one or more empirical metrics that each quantify a prior performance of the first process by the security operations center; and

the processor deriving a value of a process-capability index C(p), wherein the value of C(p) quantifies, as a function of the first metric, the security operations center's ability to consistently meet quality standards when performing the first process p during the standard time period.

A second embodiment of the present invention provides a computer program product, comprising a computer-readable hardware storage device having a computer-readable program code stored therein, said program code configured to be executed by a processor of a computer system to implement a method for measuring proficiency and efficiency of a security operations center, wherein the security operations center performs a plurality of processes, the method comprising:

the processor receiving information about the security operations center's prior performance during a standard time period of a first process p of the plurality of processes;

the processor interpreting the received information to generate a plurality of values of one or more empirical metrics,

wherein the one or more empirical metrics comprise cycle times, handle times, response times, work-in-progress levels, and throughputs of the security operations center, and

wherein a first subset of the plurality of values comprises values of a first metric of the one or more empirical metrics that each quantify a prior performance of the first process by the security operations center; and

the processor deriving a value of a process-capability index C(p), wherein the value of C(p) quantifies, as a function of the first metric, the security operations center's ability to consistently meet quality standards when performing the first process p during the standard time period.

A third embodiment of the present invention provides a computer system comprising a processor, a memory coupled to said processor, and a computer-readable hardware storage device coupled to said processor, said storage device containing program code configured to be run by said processor via the memory to implement a method for measuring proficiency and efficiency of a security operations center, wherein the security operations center performs a plurality of processes, the method comprising:

the processor receiving information about the security operations center's prior performance during a standard time period of a first process p of the plurality of processes;

the processor interpreting the received information to generate a plurality of values of one or more empirical metrics,

wherein the one or more empirical metrics comprise cycle times, handle times, response times, work-in-progress levels, and throughputs of the security operations center, and

wherein a first subset of the plurality of values comprises values of a first metric of the one or more empirical metrics that each quantify a prior performance of the first process by the security operations center; and

the processor deriving a value of a process-capability index C(p), wherein the value of C(p) quantifies, as a function of the first metric, the security operations center's ability to consistently meet quality standards when performing the first process p during the standard time period.

### BRIEF DESCRIPTION OF THE DRAWINGS

FIG. 1 shows the structure of a computer system and computer program code that may be used to implement a method for measuring proficiency and efficiency of a security operations center in accordance with embodiments of the present invention.

FIG. 2 is a flow chart that overviews steps of a method for measuring proficiency and efficiency of a security operations center in accordance with embodiments of the present invention.

FIG. 3 is a flow chart that describes, in greater detail, a method for measuring proficiency and efficiency of a security operations center in accordance with embodiments of the present invention.

### DETAILED DESCRIPTION

Methods of the present invention capture, collect, or analyze information about an operation of a Security Operations Center (SOC) or other service provider and then aggregate and mathematically manipulate the information to derive novel metrics that may identify or characterize a proficiency, efficiency, or other relevant characteristic of the organization or set standards by which performance may be measured.

Embodiments of the present invention may provide such benefits to any type of business function or organization that may be characterized as a function of throughput, work-in-progress levels, or other metrics that describe how successfully the organization or business function handles a variable workload that requires the servicing of unscheduled service requests.

In order to improve readability, this document may at times describe such an organization or business function as a “Security Operations Center” or “SOC.” Such references, however, should not be construed to limit embodiments of the present invention to an SOC. Analogous embodiments may extend or apply any method, step, implementation, or embodiment of the present invention to other types of business functions and operations and, in particular to organizations and business functions that act as service providers.

Firstly, embodiments of the present invention may identify an SOC's proficiency, or ability to consistently satisfy business objectives when responding to service requests, wherein consistency may be defined as an ability to meet objectives with a specified confidence interval. If, for example, the SOC maintains an objective of satisfying a service request within two hours of beginning work on the request at least 95% of this time, the proficiency of this process or function would be identified as a function of whether the SOC has historically been able to service more or less than 95% of incoming service requests within two hours.

Embodiments of the present invention may also derive performance targets as a function of proficiency figures and the collected SOC statistical data. In one example, a “CTW” (Cycle time/Throughput/Work-in-progress) ratio may express a historical work-in-progress value as a function of average cycle times and throughput values. Such a derived work-in-progress value may be used as a standard by which SOC management may identify a target cycle time when an SOC's throughput changes, or identify a target throughput requirement when the SOC's average cycle time varies. The derived work-in-progress value target may further be used to forecast the SOC's ability to meet workload requirements by comparing the SOC's actual current work-in-progress averages to the derived work-in-progress target value. One novel aspect of such an embodiment is a synchronization of an SOC's historic proficiency (from which the CTW average cycle times are identified) with the SOC's incident-completion rate (which is a function of the CTW throughput).

Finally, embodiments of the present invention may characterize an efficiency of an SOC, or of a process or function performed by an SOC as a function of the SOC's response times, cycle times, and handle times. One novel aspect of such an embodiment is its synchronization of an SOC process efficiency (or “SPCE”) with the SOC's previously derived historic proficiency (which is related to SOC response times, cycle times, and handle times).

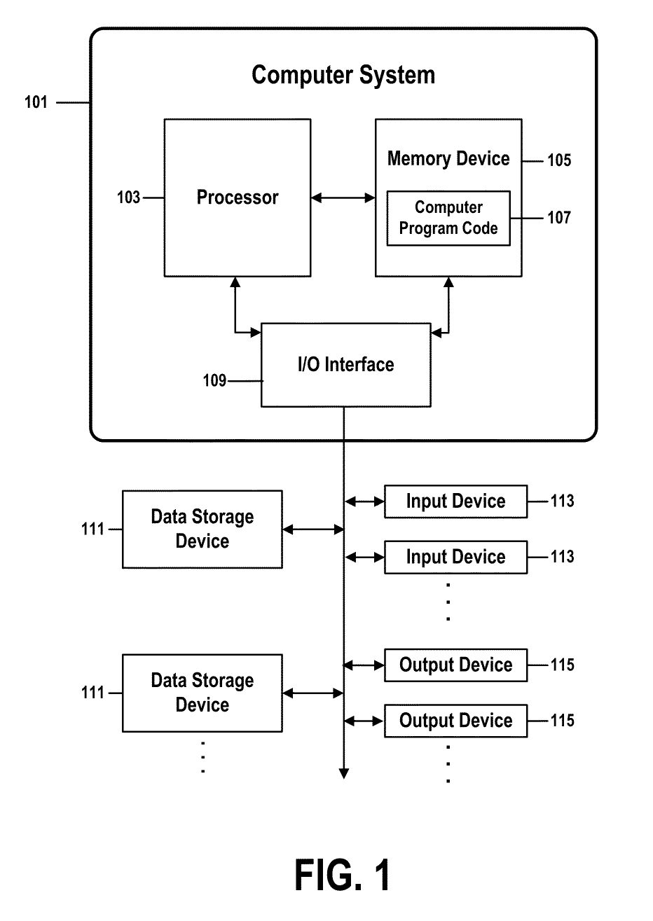

FIG. 1 shows a structure of a computer system and computer program code that may be used to implement a method for measuring proficiency and efficiency of a security operations center in accordance with embodiments of the present invention. FIG. 1 refers to objects 101-115.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for measuring proficiency and efficiency of a security operations center in accordance with embodiments of the present invention, and may implement other embodiments described in this specification, including the methods illustrated in FIGS. 1-3. The data storage devices 111 may store the computer program code 107. Computer program code 107 stored in the storage devices 111 is configured to be executed by processor 103 via the memory devices 105. Processor 103 executes the stored computer program code 107.

Thus the present invention discloses a process for supporting computer infrastructure, integrating, hosting, maintaining, and deploying computer-readable code into the computer system 101, wherein the code in combination with the computer system 101 is capable of performing a method for measuring proficiency and efficiency of a security operations center.

Any of the components of the present invention could be created, integrated, hosted, maintained, deployed, managed, serviced, supported, etc. by a service provider who offers to facilitate a method for measuring proficiency and efficiency of a security operations center. Thus the present invention discloses a process for deploying or integrating computing infrastructure, comprising integrating computer-readable code into the computer system 101, wherein the code in combination with the computer system 101 is capable of performing a method for measuring proficiency and efficiency of a security operations center.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise said computer-readable hardware storage device.

While it is understood that program code 107 for cross-retail marketing based on analytics of multichannel clickstream data may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for cross-retail marketing based on analytics of multichannel clickstream data is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

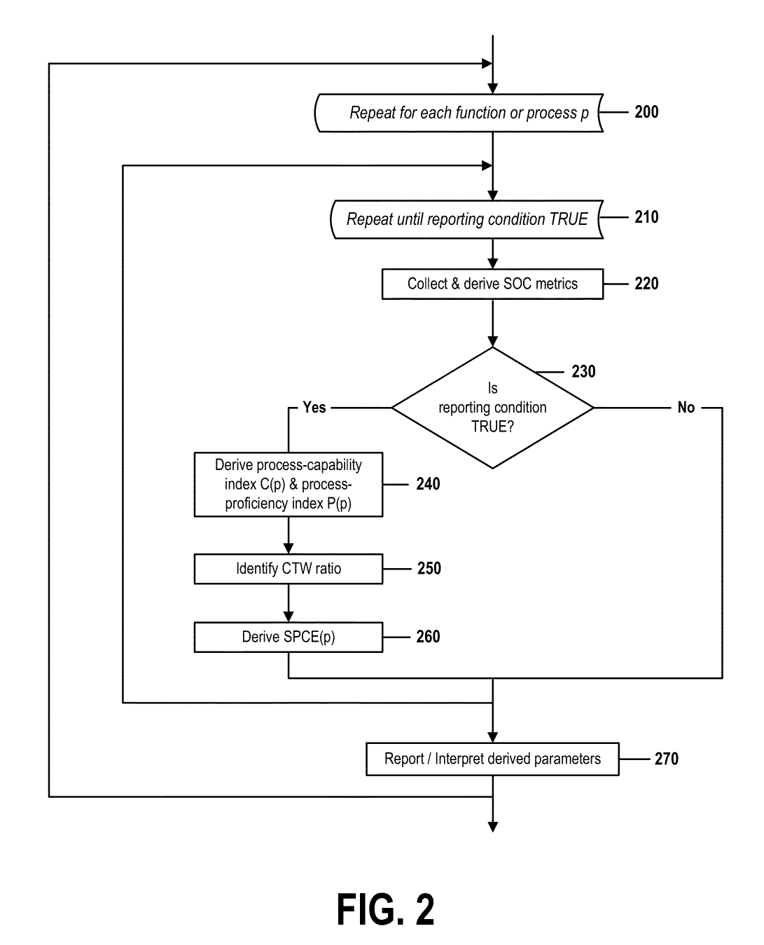

FIG. 2 is a flow chart that overviews steps of a method for measuring proficiency and efficiency of a security operations center in accordance with embodiments of the present invention. FIG. 2 contains steps 200-270 arranged in a pair of nested loops: an outer-nested iterative procedure of steps 200-270 and an inner-nested iterative procedure of steps 210-260.

Step 200 initiates the outer iterative procedure of steps 200-270. In each iteration of this iterative procedure, one or more processors derives parameters that may be used to measure a proficiency and an efficiency of a Security Operations Center (SOC)'s performance of a process, a business function, a class of activities, or of some other type of task comprised by the SOC's general operation. Embodiments described in FIGS. 1-3 generally describe methods associated with performance of processes related to servicing incoming service requests, but this should not be construed to limit embodiments of the present invention to such performances.

Each iteration of the outer iterative procedure of steps 200-270 will consider one such process p. Examples of such a process p may comprise, but are not limited to, a combination of: examining a user's computer for a malware infestation; prioritizing an incoming threat report, for responding to a particular class of incoming threat; or documenting status of a reported incident. Many other examples are possible, including, but not limited to, examples that appear throughout this document.

Although not expressly shown in FIG. 2, the one or more processors may in step 200 facilitate logic of a method of FIG. 2 by setting or resetting an implementation-dependent reporting condition to a default value of FALSE, thus indicating that the current embodiment is not yet ready to compute and report proficiency and efficiency indices and ratios in steps 240-270. In addition, this FALSE value ensures that the inner-nested iterative procedure of steps 210-260, which repeats until the reporting condition becomes TRUE, will be performed at least once for each iteration of the outer procedure of steps 200-270.

Step 210 initiates the inner nested iterative procedure of steps 210-260, which, as described above, repeats until the reporting condition becomes TRUE. Each iteration of the outer procedure of steps 200-270 continues to initialize the reporting condition to a default value of FALSE in step 200, thereby ensuring that the inner procedure is performed at least once for each iteration of the outer procedure.

If, however, the one or more processors determine the reporting condition to be TRUE, the current iteration of the inner loop terminates and the method of FIG. 2 continues with step 270.

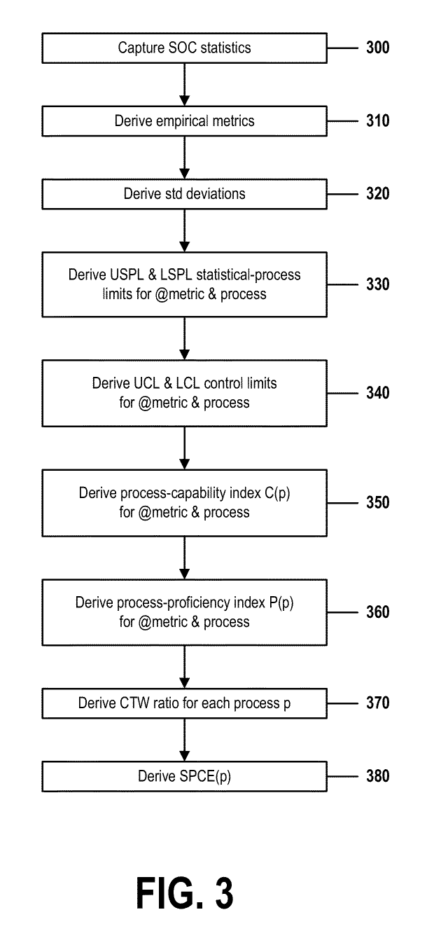

In step 220, the one or more processors collect statistical, archived, or historical information, such as transaction logs, job tickets, time sheets, other types of tracking data, or values of empirical metrics, that describes performance characteristics of the SOC, as described in more detail in steps 300-310 of FIG. 3. In some embodiments, the one or more processors may in step 220 derive a value of an empirical metric as a function of information collected in step 210.

In step 230, the one or more processors determine whether the reporting condition is TRUE. If the condition is TRUE, the method of FIG. 2 continues with steps 240-260. If the condition is FALSE, the current iteration of the inner procedure of steps 210-260 ends and the next iteration of the inner procedure begins.

In this embodiment, the inner procedure thus continues to collect statistical information or empirical metrics until a TRUE reporting condition occurs. When this TRUE condition occurs, the one or more processors perform steps 240-260 in order to derive a set of novel parameters from the collected information, communicate or report the novel parameters in step 270, and then begin a next iteration of the outer procedure of steps 200-270.

In other embodiments, alternative logical structures may be substituted for the nested-loop structure shown here. The information-collecting tasks of step 220 may, for example, be performed once, either as real-time procedure or by reading or interpreting previously stored data, and would then be followed by the derivation and reporting procedures of steps 240-270. In yet other cases, the information-collecting task of step 220 may be performed concurrently or in parallel with one or more iterations of the procedure of steps 240-270.

Other types of logical workflows are possible and embodiments of present invention may perform the information-gathering, parameter-derivation, and reporting steps sequentially, in parallel, or in any combination thereof that allows the derivation of the novel parameters in steps 240-260.

In the embodiment shown in FIG. 2, the reporting condition may comprise any combination of conditions that indicate whether the method should begin deriving the set of novel proficiency and efficiency parameters in steps 240-260. If derivation and reporting are performed in accordance with a timed schedule, the reporting condition might be an occurrence of a certain time of day, a day of the week, day of the month, or calendar date. If derivation and reporting are to be performed in response to a detection of a likelihood that a characteristic of the SOC operation requires management attention, then the reporting condition might become TRUE if an empirical metric collected or derived in step 220 indicates a low throughput, a high cycle time, an excessive number of work-in-progress tasks, or some other value that exceeds, does not exceed, satisfies, or does not satisfy a threshold value. In some embodiments, a complex reporting condition may comprise a combination of conditions.

Selection of a reporting condition may be implementation-dependent and may be a function of an objective or goal of the SOC or of an other business function, or may be a function of a characteristic of the SOC, of the types of processes it performs, or of the entities it serves.

If the one or more processors determine that the reporting condition is TRUE in step 230, the method of FIG. 2 continues with step 240. Here, as described in more detail in steps 330-380 of FIG. 3, the processors perform mathematical or statistical computations that derive process-capability and process proficiency indices for each combination of SOC process and empirical metric. These indices may identify how proficient the SOC performs each process, as a function of each empirical metric collected or derived in step 220. In some embodiments, these empirical metrics may comprise an SOC's cycle time, handle time, or response time when responding to service requests related to the particular SOC process, function, or activity currently under consideration. These empirical metrics are explained in greater detail in the description of step 310 of FIG. 3.

In step 250, as described in more detail in step 370 of FIG. 3, the one or more processors perform further mathematical or statistical computations on the statistical information and metrics collected or derived in steps 220 and 240. These further computations identify a cycle-time/throughput/work-in-progress (CTW) ratio that may be used to develop performance targets associated with the SOC's performance of a process, function, or activity.

In one example, the ratio may define the SOC's historic average work-in-progress level as a function of the SOC's historic average cycle times and historic average throughput, where a work-in-progress (WiP) level may identify how many service requests are currently being serviced by the SOC, but have not been completed. If this historic average WiP level is selected as a target level, the CTW ratio allows computation of a target average cycle time as a function of a current average throughput and, conversely, allows computation of a target average throughput as a function of a current average cycle time.

In step 260, as described in more detail in step 380 of FIG. 3, the one or more processors may perform further mathematical or statistical computations on the information and metrics collected or derived in steps 220-250. These further computations may identify a process-efficiency index SPCE(p) that identifies how efficiently the SOC performs process p.

The completion of step 260 concludes the current iteration of the inner procedure of steps 210-260 in response to the current TRUE state of the reporting condition. The outer procedure of steps 200-270 then continues with step 270.

In step 270, the one or more processors may communicate information about the proficiency, efficiency, or other characteristic of the SOC as a function of the parameters computed in steps 240-260. This communicated information may be in a form of raw statistics, a graph, a table, an interactive display, a “what-if” analysis tool, or an other form of communication that provides information deemed relevant to understanding performance characteristics of the SOC.

In some embodiments, step 270 may not be performed once for every iteration of the outer procedure of steps 200-270. In certain embodiments, step 270 may be performed only if information collected or derived during iterations of step 220 is sufficient in quality or quantity to allow the processors in steps 240-260 to derive or compute statistically meaningful values.

In some embodiments, step 270 may report accumulated or aggregated information, derived or computed from information collected during multiple iterations of the outer procedure of steps 200-270. In such cases, step 270 may communicate information about the SOC's overall proficiency, efficiency, or other characteristic, or about the SOC's overall proficiency, efficiency, or other characteristic when performing more than one type of process, function, or activity.

At the conclusion of step 270, the current iteration of the outer iterative procedure of steps 200-270 terminates. If another process p1 is to be analyzed, the method of FIG. 2 may then continue with a next iteration of the outer procedure, which considers process p1.

FIG. 3 is a flow chart that describes, in greater detail, a method for measuring proficiency and efficiency of a security operations center in accordance with embodiments of the present invention. FIG. 3 comprises steps 300-380.

In step 300, one or more processors of a computer system capture, load, or otherwise collect information that may be interpreted as, or translated into, empirical metrics that may characterize performance of a Service Operations Center (SOC) or other business function or organization that performs processes that service user-generated service requests.

This collecting may occur over a period of time sufficient to allow a statistically meaningful amount of data to be accumulated, averaged, or otherwise analyzed. A duration of this period of time may be selected as a function of a detail specific to a particular embodiment or implementation of the present invention; as a function of a characteristic of the SOC, such as the SOC's historic, current, or average throughput, incoming-incident frequency, hours of operation, or workload variability; as a function of a characteristic of a user supported by the SOC; or as a function of a characteristic of a type of task or of a goal or objective of the SOC.

In one example, a processor may capture raw data from an SOC at the end of each 24-hour day because the SOC's incident-management software makes such data available as daily end-of-day status reports that log each incoming incident or service request. In another example, in which an SOC's transaction-management application logs changes to a service-request status in real time, and wherein SOC staff is scheduled in three daily 8-hour shifts, an embodiment of the present invention might collect data continuously, as it become available, and then aggregate an 8-hour block of collected data at the end of each shift.

In yet another example, wherein daily rates of incoming incidents are known to fluctuate, data may be collected, aggregated, or averaged over a longer period of time, in order to obtain enough data points to allow a curve-smoothing function to identify an overarching trend or to compensate for transient, biasing factors. As will be described in the explanation of step 360 below, methods of the present invention may derive analogous process-capability index C(p) and process-proficiency index P(p) that differ only in the duration of time covered by the raw data from which they are derived. In such a case, the C(p) might provide information about an SOC's performance when performing process p under current conditions, and t the P(p) might compensate for a short-term bias characteristic of current conditions by providing analogous information about an SOC's performance when performing process p over a longer period of time.

Information collected in step 300 may comprise any type of data from which an embodiment of the present invention may infer a characteristic of the SOC. Such data may be captured, logged, aggregated, or otherwise analyzed by automated or manual means known to those skilled in the art or by proprietary means unique to the SOC or to an embodiment of the present invention.

In embodiments described herein, collected information may identify a characteristic of an incoming incident, such as a service request, wherein the SOC staff responds to the incoming incident or request by performing one or more processes, activities, or tasks.

Such collected information might, for example, comprise: a type or classification of a service request, an arrival time that identifies a time when the SOC first received notice of a service request, a time when a service request was placed in a queue to await servicing, a time at which an SOC staff member began servicing a queued service request, a time at which a status of a service request changes, a time at which a service request is abandoned by the SOC or canceled by a requester, or a time at which SOC staff complete all processes or tasks related to a service request.

In embodiments described herein, a set of such data may be collected for each function or process p performed by the SOC. If, for example, a SOC performs 24 classes of processes, functions, activities, or tasks, such as applying a security patch, installing a software application, curing a malware infection, or responding to a report of a breach, then the one or more processors may collect 24 sets of data, each of which is associated with tasks related to one class of process, function, activity, or task. Alternatively, the processor might collect one overall set of data points and, in step 300 or in a later step, then organize or sort the captured data into 24 groups.

In yet other cases, in this example, an iteration of a method analogous to the method of FIG. 3 might collect data for just one class of process or function or for just one subset of the 24 possible classes, thus requiring as many as 24 iterations to fully characterize all processes, functions, activities, tasks, or other operations associated with the SOC.

In some cases, captured or collected information may be culled from incident “tickets” that log characteristics of each incoming incident or service request, wherein such characteristics might comprise combinations of an incident's arrival time, wait time while in queue, status, change in status, priority, change in priority, or time of completion.

This document describes a method of FIG. 3 that measures an SOC's proficiency and efficiency related to the SOC's performance of one class or type of process or function. This simplification is made to improve readability, and should not be construed to limit embodiments of the present invention to single-function embodiments or to exclude multi-function embodiments, such as those described above and in FIG. 2.

In step 310, the one or more processors use the raw historical data collected in step 300 to derive a set of time-averaged empirical metrics associated with the SOC's performance of one type of process or function. In some embodiments, the period of time over which this raw data are collected or averaged may be selected so as to provide information about the SOC's current activity. In one example, data may be collected every day. In another example, it may be collected hourly and aggregated into seven-day blocks so as to produce weekly averages. In other embodiments, data may be collected or averaged over longer periods, as a function of implementation-specific requirements, technical or business constraints, other procedural requirements, or organizational goals.

In embodiments described herein, information may be collected step 300 in one or more iteration of FIG. 3 to allow both current and long-term analyses. In one example, a shorter-term process-capability index C(p) and a longer-term process-proficiency index P(p) may provide both current and long-term characterizations of the SOC's proficiency at performing process p.

The first such empirical metric may be response time, which identifies a duration of time that starts when an incoming service request is enqueued and ends when SOC staff begins to actively respond to the request.

In one example, a service request that is received by the SOC at 8:12 AM may be forwarded to a wait queue at 8:15 AM, and then removed from the queue for servicing by a service specialist at 8:30 AM. In this example, this service request would be associated with a 15-minute response time.

In some embodiments, the one or more processors may in step 300 have collected or otherwise identified a response time previously recorded by a data-gathering mechanism. In other embodiments, the one or more processors may themselves in step 310 derive a response time as a function of a previously collected first time at which a service request is enqueued and a previously collected second time at which an SOC staff member of other service provider removes the service request from the queue in order to begin work on the request.

A second empirical metric may be handle time, which is a duration of actual work hours required to complete or fully service a task related to responding to a service request. If, for example, one or more SOC service technicians spends 3.2 hours over the course of three days to resolve a reported malware infection, that malware disinfection process would be characterized by a 3.2-hour handle time.

In some embodiments, the one or more processors may in step 300 have collected or otherwise identified a handle time previously derived by a data-gathering mechanism. In other embodiments, the one or more processors may themselves derive a response time as a function of having collected or otherwise identified information in step 300 from which a handle time may be derived, such as an one or more SOC service technicians reported work-time or billing data.

A third empirical metric may be cycle time, which is a duration of time starting from a first time at which an incident or service request is created or received by the SOC through a second time at which the SOC completes its work on the incident or service request. Alternate types of cycle-time metrics are explained below in the description of step 370.

In one example, a malware incident reported to the SOC at 8:00 AM may be forwarded to a wait queue at 8:15 AM, removed from the queue by a service specialist at 8:30 AM, and forwarded by the specialist to an external technical expert at 9:30 AM that same morning. The specialist does not work continuously on the service request during the hour between 8:30 and 9:30, instead devoting a total of 18 minutes of actual work time speaking to the service requestor, analyzing the reported incident, and identifying the external technical expert. In this example, the reported incident would be associated with a 75-minute cycle time, which identifies the duration of time between the SOC's 8:15 AM notification of the incident and the 9:30 AM conclusion of the SOC's work on the incident. The reported incident would further be associated with an 18-minute handle time.

In some embodiments, the one or more processors may in step 300 have collected or otherwise identified a cycle time previously derived by a data-gathering mechanism. In other embodiments, the one or more processors may themselves derive a response time as a function of having collected or otherwise identified information in step 300 from which a cycle time may be derived.

The one or more processors may thus, in step 310, collect or derive a first set of response times, a second set of handle times, and a third set of cycle times for one or more SOC functions, activities, or processes p under consideration.

If the one or more processors consider only one, or one type of, function, activity, or process p during one performance of the method of FIG. 3, then all response times, handle times, and cycle times collected or derived in steps 300 and 310 are associated with that one, or that one type of, function, activity, or process p. The one or more processors may then average each of these three sets of data to produce a mean response time, a mean handle time, and a mean cycle time for p, for that specific period.

If the one or more processors consider more than one, or one type of, function, activity, or process p during one performance of the method of FIG. 3, then the one or more processors collect or derive in steps 300 and 310 a set of response times, a set of handle times, and a set of cycle times for each considered p. The one or more processors may then average each collected or derived set of data to produce a mean response time, a mean handle time, and a mean cycle time for each p under consideration, during the same period of time.

In either case, a mean response time, mean handle time, and mean cycle time that are all associated with a same, or with a same type of, function, activity, or process p may be averaged over a substantially identical period of time in order to ensure that all three averages identify SOC performance during the same period of time.

It is possible that, in some embodiments, two or more of a set of three means, derived in this step and associated with a same p, may be derived from data collected over different periods of time. This may occur, for example, if such inconsistent sampling is deemed necessary to reduce or eliminate a bias, to more accurately portray an SOC's real-world activity, or to compensate for an other distorting event or characteristic of the information collected in step 300.

In some embodiments, the one or more processors may in step 310 further derive work-in-progress (WiP) and throughput metrics that characterize the SOC's performance when performing an activity, function, or process p.

Within this context, a throughput figure may identify or characterize an amount of work, a number of service requests, or a number of other tasks that is completed by the SOC, or by a business function comprised by the SOC, during a particular time period. If, for example, raw statistical data gathered over a one-week period indicates that, during that week, the SOC completed its work on 37 security threats, regardless of when each of those 37 threats had originally been received, then the one or more processors might derive or identify a throughput figure for that one-week period of 37 threats.

Like the other empirical metrics collected or derived in steps 300 and 310, a distinct value of throughput may be identified for each process, function, or activity performed by or comprised by a SOC. For example, a distinct throughput value may be derived for a process or function of monitoring a state of a user environment, for tasks related to a triage of incoming threats, for tasks related to responding to an incoming threat, or for work performed to manage a reported incident. A throughput of a process, function, or activity may be distinct from an overall throughput that characterizes operations of an SOC in aggregate.

Within the context of step 310 of FIG. 3, a WiP figure may identify or characterize an amount of work, a number of service requests, or a number of other tasks that are being worked on by SOC staff, but that have not yet been completed. Consider, for example, raw statistical data gathered over a one-week period ending today that indicates: i) at the beginning of the one-week period ending today, 30 service requests were either enqueued and waiting assignment to an SOC specialist, or had already been assigned, but had not yet been completed; ii) during the course of the one-week period ending today, 150 new service requests arrived; iii) during the course of the one-week period ending today, SOC specialists completed work on 140 service requests. In this example, the one or more processors might derive a current WiP figure equal to 40 (30+150−140), which identifies that the SOC is working on 40 service requests.

As with response time, handle time, and cycle time, mean WiP and mean throughput metrics may be derived by time-averaging WiP and throughput figures collected or derived over one or more periods of time. As with mean response time, mean handle time, and mean cycle time metrics, these averages should be calculated over substantially identical periods of time unless there is an implementation-dependent reason to consider different periods of time.

As with response time, handle time, and cycle time, WiP and throughput metrics may be organized by a function, activity, or process p, or by a class of function, activity, or process p, with which the metrics are associated. In some embodiments, the processor in step 310 may assemble five sets of data and five corresponding means—response time, handle time, cycle time, WiP, and throughput—for each p under consideration.

In step 320, the one or more processors derives standard deviations for, respectively, the response time, handle time, and cycle time data points collected, derived, or averaged in steps 300 and 310. In some embodiments, the one or more processors may further derive standard deviations for the WiP and throughput data that may have been collected, derived, or averaged in steps 300 and 310.

These standard deviations may be derived by using mathematical methods, tools, or techniques known to those skilled in the art of statistics. It is further known in the art that a standard deviation of a population of data points characterizes a degree of dispersion of the points around a mean or average value of the data points. In one example, if a first set of values of a response-time metric is associated with a higher standard deviation, those values will vary from the mean more than do a second set of response time values associated with a smaller standard deviation.

A lower standard deviation of a data set thus indicates that the values comprised by the data set are more tightly clustered around the mean, and may further indicate that the mean is a more accurate approximation of the data. Conversely, a higher standard deviation would indicate that the values a higher degree of variability and are less tightly clustered around the mean.

In step 330, the one or more processors uses information collected or derived in steps 300-320 to identify an upper statistical process limit (USPL) and a lower statistical process limit (LSPL) for each combination of an SOC process, function, or activity under consideration and an empirical metric collected or derived in steps 300-310. Each USPL/LSPL pair is thus associated with one class of SOC process, function, or activity and with one empirical metric.

If, for example, the one or more processors collect, receive, or derive information in steps 300-310 that characterizes the SOC's performance of a first SOC process and a second SOC process over a first time period, the one or more processors in step 330 might identify a first USPL/LSPL pair that identifies upper and lower statistical limits of the SOC's response time for the first process, a second USPL/LSPL pair that identifies upper and lower statistical limits of the SOC's handle time for the first process, and a third USPL/LSPL pair that identifies upper and lower statistical limits of the SOC's cycle time for the first process. In addition, the method of FIG. 3 might further identify a fourth USPL/LSPL pair that identifies upper and lower statistical limits of the SOC's response time for the second process, a fifth USPL/LSPL pair that identifies upper and lower statistical limits of the SOC's handle time for the second process, and a sixth USPL/LSPL pair that identifies upper and lower statistical limits of the SOC's cycle time for the second process.

In some embodiments, the six USPL/LSPL pairs of this example might be derived from data sets that all span the first time period. In other embodiments, the six USPL/LSPL pairs might be derived from a subset of the first time period or from data that spans a time period all or partly different from the first time period, so long as all six USPL/LSPL pairs are derived from data that spans the same time period. In yet other embodiments, the six USPL/LSPL pairs may not be derived from data that spans the same time period, if it is deemed necessary to select some data points from a different time period in order to mitigate a bias or other distorting characteristic of the data.

In some embodiments, a USPL statistical limit associated with a first metric and with a first set of values may be selected as being three standard deviations greater than the mean value of first set of values. Similarly, in some embodiments, an LSPL statistical limit associated with the first metric and with the first set of values may be selected as being three standard deviations less than the mean of first set of values.

In one example of such embodiments, if a set of SOC response times collected or derived in steps 300-310 and associated with a first SOC process p, has a mean value of 20 minutes and a standard deviation of 2 minutes, a USPL for that set of response times might be 26 minutes (20+3*2) and an LSPL for that set of response times might be 14 minutes (20−3*2). Such limits would imply that, if the SOC took more than 26 minutes or less than 14 minutes to respond to a service request associated with process p, the response time would be considered to have exceeded a statistical limit of acceptability established by the SOC's previous performance of similar tasks.

In other embodiments, USPL and LSPL values may be derived by means of different formulas, using criteria that may be known to a person skilled in the art of business science or statistical analysis, or that may be known to a person who possesses expert knowledge of the SOC, of the business or business function that manages the SOC, of the SOC's clients, of an industry within the SOC operates, or of other implementation-dependent criteria. In some cases, a USPL/LSPL pair may identify values that are not symmetrically distributed about a mean value of a data set. In other cases, a value of a USPL or LSPL may be proactively adjusted in anticipation of a future change to, or in response an identified trend in, a workload, throughput, work-in-process and/or handle time.

At the conclusion of step 330, the one or more processors will have derived a pair of process-control limits for each data set associated with each process, activity, or function of the SOC that is under consideration by the current performance of a method of FIG. 3. In some embodiments, the processors will have derived a first pair of USPL/LSPL statistical limits for the SOC's response time when the SOC responds to an incident associated with a first SOC process p1, a second pair of USPL/LSPL statistical limits for the SOC's handling time when the SOC responds to incident associated with p1, and a third pair of USPL/LSPL statistical limits for the SOC's cycle time when the SOC responds to an incident associated with p1.

Each such limit may identify a maximum or minimum desirable value of the corresponding empirical metric, based on a statistical model derived from past performance statistics. For example, in the example above, if a set of response times is associated with an USPL of 26 minutes and a LSPL of 14 minutes, a response time of 30 minutes might be deemed to be unacceptably long, and a response time of 9 minutes might be deemed to indicate a time-reporting error or a failure of a specialist to conform to best practices.

In step 340, the one or more processors determine a pair of upper and lower control limits UCL and LCL for each data set collected or derived in steps 300-310. Each pair of control limits is thus associated with one empirical metric, such as response time, handle time, or cycle time, and with activity, function, or process p, or one class of activity, function, or process p, performed by the SOC.

These second pairs of limits identify goal or target values of each empirical metric. Here, a goal or target may be a function of: an extrinsically identified value, such as a maximum response time or handle time identified by: terms of a Service-Level Agreement (SLA) or other type of service contract; a management or business goal; a client requirement; a hardware, software, communications, or other resource-related constraint; or of some other implementation-dependent criteria.

In one example, an SOC's response times when responding to service requests for an SOC process p is associated by in step 330 with a 26-minute USPL and a 14-minute LSPL. In step 340, the processor or processors might further identify a response-time Upper Control Limit (UCL) of 21 minutes and a response-time Lower Control Limit (LCL) of 3 minutes. Although both pairs of limits may be used to identify outlying or undesirable response times, a first response time may fall outside one pair of limits, but remain within the other pair. In this example, a 22-minute response time would fall outside the 3-to-21-minute control range delimited by the UCL and LCL, but would remain within an acceptable range identified by the statistically derived USPL/LSPL range of 14-26 minutes.

Some embodiments may require a pair of UCL/LCL control limits associated with a same data set to be equidistant from a mean of that data set. As shown in the preceding example, other embodiments may not require such symmetry about the mean.

In some embodiments, a UCL of a first data set may be larger than, less than, or equal to a USPL of the first data set. In some embodiments, an LCL of the first data set may be larger than, less than, or equal to a LSPL of the first data set. In some embodiments, a UCL or LCL may be required to be greater, less, more distant from the mean, or closer to the mean than a corresponding statistical-process limit. In some embodiments, an LCL/UCL pair may be required to define a desirable range that is larger than, less than, or equal to a desirable range delimited by a corresponding pair of statistical-process limits.

At the conclusion of step 340, the one or more processors will have identified a four limit—one pair of statistical-process limits and one pair of control limits—for each combination of an empirical metric collected or derived in steps 300-310 and an SOC process, activity, or function under consideration. Each pair of statistical-process limits identifies an expected range of values of a particular metric based on the SOC's past performance of tasks associated with a particular process, and each pair of control limits identifies a target range of values of a particular metric when performing a particular process, based on the SOC's goals, objectives, or commitments.

In step 350, the one or more processors derive a process-capability index C(p) for each data set collected in step 300 and processed in steps 310-340. A set of distinct C(p) values is thus derived for each combination of one empirical metric collected or identified in steps 300-310 and each SOC process, activity, or function p that is under consideration by the method of FIG. 3.

A C(p) value that is associated with a particular data set may be a function of the control limits UCL and LCL and the statistical-process limits USPL and LSPL (derived respectively in steps 330 and 340) associated with that particular data set.

In embodiments described herein, C(p) for a first data set and a first empirical metric may be derived by the equation:

$$C ( p ) = \frac{UCL - LCL}{USPL - LSPL}$$

Here, if the first data set comprises recorded response times associated with the SOC's handling of service requests related to malware infections during a first time period, then:
UCL is an upper control limit identified in step 340 and associated with the SOC's response times when service requests related to malware infections during the first time period,
LCL is a lower control limit identified in step 340 and associated with the SOC's response times when service requests related to malware infections during the first time period,
USPL is an upper statistical-process limit identified in step 330 and associated with the SOC's response times when service requests related to malware infections during the first time period, and
LSPL is a lower statistical-process limit identified in step 330 and associated with the SOC's response times when service requests related to malware infections during the first time period.

A C(p) index thus comprises a ratio between a target range of metric values (UCL-LCL) that satisfy an SOC's goals or obligations, and an expected range of metric values (USPL-LSPL) that is derived as a statistical function of the SOC's past performance. In some embodiments of the present invention, the USPL-LSPL expected range may have been determined by the one or more processors in step 330 to have a width equivalent to six times the standard deviation of a set of values of an empirical metric collected or derived in steps 300-310, and may have further been determined to be centered around a mean value of the set of values. Such a range is known by statisticians to comprise more than 99.7% of all data values of such a data set, and may thus be used to estimate a range of future values of future data points.

A value of C(p) that is greater than 1 implies that, for the empirical metric and the SOC process p associated with this value of C(p), a numerator range of acceptable metric values (as identified by a goal or obligation of the SOC) is greater than a denominator range of expected metric values that might be expected with 99.7% confidence. In this example, a C(p) greater than 1 indicates that the SOC is capable of performing process p with proficiency, wherein proficiency is identified as a probability of at least 99.7% that an SOC's response time when performing process p will fall within the six standard-deviation range delimited by values of USPL and LSPL.

Consider, for example, a C(p) index that identifies a response-time capability of an SOC process p that comprises servicing requests for software security-patch installations. In this example, an associated UCL and LCL respectively identify target limits of 75-minute and 69-minute response times, and a standard deviation associated with a response-time data set for this security-patch function has been identified in step 320 as having a value of 1.79.

In this example, we thus derive a value of C(p) as:

$$C ( p ) = \frac{UCL - LCL}{USPL - LSPL}$$

$$C ( p ) = \frac{UCL - LCL}{6 * StdDev}$$

$$C ( p ) = \frac{75 - 69}{6 * 1.79} = \frac{6}{10.74} = 0.56$$

Here, the process p in question—responding to requests for software security-patch installations—is found to be incapable of being performed by the SOC with proficiency because its associated C(p) process-capability index is less than 1. In other words, expected response times associated with this function that fall within six standard deviations of a historical mean of such response times cannot be expected with sufficient confidence to fall within a desired target range identified by the upper and lower control limits. Expressed another way, C(p) indicates that the SOC cannot be expected with 99.7% confidence to perform a process p with proficiency sufficient enough to satisfy limits set by values of UCL and LCL.

It is unnecessary in this embodiment to insert actual values of USPL and LSPL into the C(p) calculation because, here, the difference between USPL and LSPL has been arbitrarily identified as being equal to six standard deviations of the data set from which the values of USPL and LSPL have been derived. But this simplification might not be true in other embodiments where, for example, an SOC does not need, or does not have resources necessary to ensure, a 99.7% confidence interval. In such a case, a USPL or LSPL might, for example, identify a four standard-deviation range. Such a range, while still statistically useful, would suggest a lower-than-99.7% probability that future data points would fall within that range. Other ranges are possible and may be chosen as a function of implementation-dependent details.

At the conclusion of step 260, a C(p) index will have been derived in similar manner for each combination of an empirical metric collected or derived in steps 300-310 and an SOC function, activity, or process p under consideration by the method of FIG. 3.

Here, an SOC process p associated with a process-capability index C(p) may comprise such an SOC activity or function, a class of task associated with an empirical metric, or combinations thereof. Examples of such a process may comprise, but are not limited to tasks related to a triage of incoming threats, tasks related to responding to an incoming threat, or tasks performed in order to resolve or otherwise manage a reported incident.

In step 360, the one or more processors derive a set of process-proficiency indices P(p), each of which is associated with one process-capability index C(p) derived in step 350, with one SOC function, activity, or process p, and with one empirical metric collected or derived in steps 300-310.

A value of P(p) is derived by means of equations similar to those used to derive values of C(p) in step 350. P(p), however, is based on data accumulated over a longer period of time than the analogous data upon which a corresponding value of C(p) is based. In some embodiments, a value of P(p) associated with a particular empirical metric and a particular process p may be derived by time-averaging a set of C(p) values that are each associated with the particular empirical metric and the particular process p, and wherein each of the set of C(p) values was derived from raw data collected over a distinct period of time.

Thus, although a value of a P(p) index is based on statistical-process limits, mean values, and standard-deviation values of a set of values of an empirical metric, these factors are directly or indirectly derived from values that may be collected over months, quarters, or years, rather than hours, days, or weeks. This longer collection period may mitigate or compensate for bias in a value of C(p) caused by a variation in an SOC's performance over a longer period of time that causes average data values and standard deviations derived in step 310 to slowly shift.

The Pₚ process proficiency index may therefore be interpreted as representing an SOC's long-term process capability when performing a process p, as measured by a particular empirical metric. This interpreting may follow guidelines similar to those appropriate when interpreting a process-capability index C(p). Thus: a P(p) value >1 may indicate that the SOC is capable of, or is proficient at, performing a process; a P(p) value <1 indicates that a process or function is incapable of such proficiency and warns management that workloads, staffing, objectives, or other resources of the SOC must be adjusted in order to ensure that the SOC is likely to deliver a desired level of service over a longer period of time; and a P(p) value=1 may alert management that, although an SOC process or function is capable, it is just barely so and may require adjustment of SOC resources or procedures in order to ensure continued the SOC's proficiency in the future.

A first duration of time over which a value of P(p) is derived is necessarily greater than a second duration of time over which a corresponding value of C(p) is derived. However, there are no absolute limits to these durations. If a duration or a rate of change of a biasing factor is relatively short, both P(p) and C(p) may be derived over shorter periods of time. In other cases, one or both of these periods of time may be longer.

In one example, if an SOC's response time increases greatly during late-morning and early-afternoon hours of each day, a C(p) value might be derived from data accumulated over a one-hour period and a corresponding daily P(p) value might be derived by averaging 24 consecutive hourly values of C(p). In another example, wherein an SOC's cycle time increases at the end of each monthly accounting period, a quarterly value of P(p) might be derived by averaging 13 consecutive weekly C(p) values.

In step 370, the one or more processors identifies a CTW (Cycle time/Throughput/WiP) ratio for each class of SOC function, activity, or process p. As described above, a WiP (work-in-progress) value identifies how many service requests have been received, but not yet completed; a throughput value identifies a number of service requests that have been completed during a certain period of time, such as a day or a work shift, regardless of how long SOC staff have been working on them; and a cycle time identifies a duration of calendar time during which SOC staff identified, responded to, and completed work a service request.

A CTW ratio may identify an SOC's average work-in-progress levels as a function of its historic cycle time and its average throughput.

average WiP=cycle time*average throughput

Equivalent formulas may express cycle time and average throughput as:

$$cycle time = \frac{average WiP}{average throughput}$$

$$average throughput = \frac{average WiP}{cycle time}$$

A CTW ratio may in this context help SOC management identify more accurate and meaningful goals by allowing any of these three factors to be derived as a function of the other two. The derived factor may then be used to set a target or goal value for future performance of the SOC when performing a similar process.

If, for example, an SOC has historically experienced an average WiP of 48 threats and an average throughput of 20 threats/day, the SOC may be said to have a long-term cycle time of 2.4 days:

$$2.4 days = \frac{48 threats}{20 threats / day}$$

This 2.4-day cycle time may be set as a target value that characterizes a normal, acceptable operation of the SOC. Then, if the SOC experiences an extended decrease in throughput due to staffing or other issues, an SOC manager may use the target cycle-time value to quickly identify a target WiP level that must be achieved in order to maintain the SOC's historic cycle time. In one example, if throughput drops to 12 threats/day, average WiP levels must be decreased to an average of 28.8 threats in order to maintain the historical 2.4-day cycle time.

average WiP=target cycle time*throughput

average WiP=2.4 days*12 threats/day

28.8 threats=2.4*12 day-threats/day

Other diagnostic and predictive results may be derived by varying different elements of the CTW ratio. If, for example, the SOC's average WiP is found to have increased to a value of 96 threats, plugging this number into the CTW formula reveals that a target cycle time of 2.4 days will require the SOC to increase its daily average throughput to 40 threats/day. (2.4=96/40.)

In another example, the CTW may similarly be used to identify a historical “benchmark” work-in-progress level that allows SOC management to identify a minimum required target cycle-time when an SOC's throughput changes, or to identify a target throughput requirement when the SOC's average cycle time varies. These derived target values may be used to forecast an SOC's ability to meet workload requirements by comparing the SOC's projected or actual current performance statistics to a derived target value.

One novel aspect of such embodiments is its ability to synchronize an SOC's historic capability and proficiency indicators (which are a function of the SOC's average cycle times) with the SOC's incident-completion rate (which is a function of collected metrics from which throughput may be derived). Relationships identified by the CTW ratio may thus be used to synchronize an SOC's current incident-completion rate or average throughput when performing a certain process with the SOC's historic proficiency when performing that process.

In step 380, the one or more processors generate an SOC Process Efficiency (SPCE(p)) metric that identifies an efficiency with which the SOC performs a function, activity, or process p. Here, this efficiency may be represented as a raw number, a ratio, a fraction or proportionality, or a percent, of a portion of a total cycle time that is spent actually servicing an incoming service request. In some embodiments, the remaining portion of the total cycle time is considered to be waste, or an otherwise inefficient use of the time.

An SPCE may be derived as a ratio between previously derived cycle time and handle time metrics.

$$SPCE = \frac{average handle time}{average cycle time}$$

In one example, if statistical information or empirical metrics collected or derived in steps 300-310 indicate that, over a particular one-month period, an SOC experienced an average handle time of four hours/threat and an average cycle time of 24 hours/threat when handling requests for malware disinfection, an SPCE of the SOC's disinfection process=16.7%.

$$SPCE = \frac{4 hours / threat}{24 hours / threat}$$

$$SPCE = \frac{4}{24} = 16.7 \%$$

In some embodiments, a threshold may be set that characterizes certain ranges of SPCE values. In one example, an SPCE(p) below 10% might be deemed to indicate that an SOC is performing a process p with a great deal of waste, an SPCE(p) within a range of 11%-40% might be deemed to indicate that an SOC is performing a process p with a great deal of waste, an SPCE within a range of 41%-50% might be deemed a reasonable efficiency for a process that are implemented by an SOC as a manual procedure, and an SPCE greater than 95% might be deemed to be a reasonable efficiency for a highly automated process.

At the conclusion of step 380, the method of FIG. 3 may have generated a novel set of parameters that characterize a capability, proficiency, or efficiency of an SOC when performing one or more functions, activities, or processes, as measured by one or more empirical metrics.

Each process or SOC function may be associated with a set of control limits and with a set of statistical-process limits that respectively identify a target range of goal values of an empirical metric based on SOC objectives or goals and an expected range of values of the empirical metric based on the SOC's prior performance. These empirical metrics may comprise response times, handle times, cycle times, or other parameters associated with performance measurement.

The method of FIG. 3 may have further identified a process-capability index C(p) and a process-proficiency index P(p) for each combination of an SOC function, activity, or process p and one of the collected or derived empirical metrics. A value of each instance of C(p) may be used to identify a proficiency of the SOC when previously performing p, as measured by the corresponding empirical metric.

Similarly, a value of each instance of P(p) may be used to identify a similar or analogous proficiency (or capability) of the same p, as measured by the same empirical metric over a longer period of time, in order to compensate for biases in collected data, such as a seasonal variation in the SOC's workload or staffing, that might shift a value of the SOC's proficiency or efficiency indicators during certain months of each year.

Finally, the method of FIG. 3 will generate a CTW ratio that may be used to generate work-in-progress, cycle time, or throughput targets for future performance of the SOC, and a process-efficiency parameter that identifies how efficiently the SOC performs a particular function, activity, or process.

What is claimed is:

1. A method for measuring proficiency and efficiency of a security operations center, wherein the security operations center performs a plurality of processes, the method comprising:
a processor of a computer system receiving information about the security operations center's prior performance during a standard time period of a first process p of the plurality of processes;
the processor interpreting the received information to generate a plurality of values of one or more empirical metrics, wherein a first subset of the plurality of values comprises values of a first metric of the one or more empirical metrics that each quantify a prior performance of the first process by the security operations center; and
the processor deriving a value of a process-capability index C(p), wherein the value of C(p) quantifies, as a function of the first metric, the security operations center's ability to consistently meet quality standards when performing the first process p during the standard time period.

2. The method of claim 1, wherein the received information comprises data elements selected from a group comprising: a type or a classification of a service request; an arrival time at which a service request is received by the security operations center; a time at which a service request is entered into a queue to await servicing or when an incoming service threat is characterized as a ticket, a job, or an incident; a time at which the security operations center begins servicing an enqueued service request; a starting time or an ending time of a duration of time during which the security operations center actively services a service request; a time at which the security operations center completes its work on a service request; a duration of actual work time spent by service operations center staff working a service request; a time at which a status or a priority of a service request changes; and a time at which a service request is abandoned by the SOC or canceled by a requester.

3. The method of claim 1,
wherein a target range of the first metric identifies, as a function of a business objective of the security operations center, a range of values of the first metric associated with an acceptable performance of the first process,
wherein a statistically derived range of the first metric identifies, as a statistical function of the first subset of the plurality of values, a range of values associated with the security operations center's performance of the first process during the standard time period, and
wherein the process-capability index C(p) is derived as a function of a ratio between the target range and the statistically derived range.

4. The method of claim 3, wherein the median of the statistically derived range is a mean value of the first subset of the plurality of values, and wherein the width of the statistically derived range is equal to six times the standard deviation of the first subset of the plurality of values.

5. The method of claim 3, further comprising the processor identifying a process-proficiency index P(p) of the first metric that identifies the security operations center's time-averaged proficiency at performing the first process p, wherein the time-averaged proficiency comprises an average of a set of process-capability indices that each identify the security operations center's process-capability, as a function the first metric, to perform the first process p, and wherein the process-proficiency index P(p) characterizes the security operations center's performance over a period of time greater than the standard time period.

6. The method of claim 1, wherein the one or more empirical metrics comprise cycle times, handle times, and response times of the security operations center.

7. The method of claim 1, wherein the one or more empirical metrics comprise cycle times, handle times, response times, work-in-progress levels, and throughputs of the security operations center.

8. The method of claim 7, further comprising the processor identifying a CTW(p) ratio that characterizes the security operations center's target work-in-progress level when servicing service requests associated with the first process p, and wherein the target work-in-progress level is a function of a product of the security operations center's average cycle time when servicing service requests associated with the first process and the security operations center's average throughput when servicing service requests associated with the first process average.

9. The method of claim 7, further comprising the processor computing a value of a process-efficiency index SPCE(p) that identifies the security operations center's efficiency when performing the first process p, wherein the value of SPCE(p) is a function of a ratio between the security operations center's average handle time when servicing service requests associated with p during the standard time period and the security operations center's average cycle time when servicing service requests associated with p during the standard time period.

10. The method of claim 1, further comprising providing at least one support service for at least one of creating, integrating, hosting, maintaining, and deploying computer-readable program code in the computer system, wherein the computer-readable program code in combination with the computer system is configured to implement the receiving, interpreting, and deriving.

11. A computer program product, comprising a computer-readable hardware storage device having a computer-readable program code stored therein, said program code configured to be executed by a processor of a computer system to implement a method for measuring proficiency and efficiency of a security operations center, wherein the security operations center performs a plurality of processes, the method comprising:
the processor receiving information about the security operations center's prior performance during a standard time period of a first process p of the plurality of processes;
the processor interpreting the received information to generate a plurality of values of one or more empirical metrics,
wherein the one or more empirical metrics comprise cycle times, handle times, response times, work-in-progress levels, and throughputs of the security operations center, and
wherein a first subset of the plurality of values comprises values of a first metric of the one or more empirical metrics that each quantify a prior performance of the first process by the security operations center; and
the processor deriving a value of a process-capability index C(p), wherein the value of C(p) quantifies, as a function of the first metric, the security operations center's ability to consistently meet quality standards when performing the first process p during the standard time period.

12. The computer program product of claim 11,
wherein a target range of the first metric identifies, as a function of a business objective of the security operations center, a range of values of the first metric associated with an acceptable performance of the first process,
wherein a statistically derived range of the first metric identifies, as a statistical function of the first subset of the plurality of values, a range of values associated with the security operations center's performance of the first process during the standard time period, and
wherein the process-capability index C(p) is derived as a function of a ratio between the target range and the statistically derived range.

13. The computer program product of claim 12, wherein the median of the statistically derived range is a mean value of the first subset of the plurality of values, and wherein the width of the statistically derived range is equal to six times the standard deviation of the first subset of the plurality of values.

14. The computer program product of claim 12, further comprising the processor identifying a process-proficiency index P(p) of the first metric that identifies the security operations center's time-averaged proficiency at performing the first process p, wherein the time-averaged proficiency comprises an average of a set of process-capability indices that each identify the security operations center's process-capability, as a function the first metric, to perform the first process p, and wherein the process-proficiency index P(p) characterizes the security operations center's performance over a period of time greater than the standard time period.

15. The computer program product of claim 11, further comprising the processor identifying a CTW(p) ratio that characterizes the security operations center's target work-in-progress level when servicing service requests associated with the first process p, and wherein the target work-in-progress level is a function of a product of the security operations center's average cycle time when servicing service requests associated with the first process and the security operations center's average throughput when servicing service requests associated with the first process average.

16. The computer program product of claim 11, further comprising the processor computing a value of a process-efficiency index SPCE(p) that identifies the security operations center's efficiency when performing the first process p, wherein the value of SPCE(p) is a function of a ratio between the security operations center's average handle time when servicing service requests associated with p during the standard time period and the security operations center's average cycle time when servicing service requests associated with p during the standard time period.

17. A computer system comprising a processor, a memory coupled to said processor, and a computer-readable hardware storage device coupled to said processor, said storage device containing program code configured to be run by said processor via the memory to implement a method for measuring proficiency and efficiency of a security operations center, wherein the security operations center performs a plurality of processes, the method comprising:
the processor receiving information about the security operations center's prior performance during a standard time period of a first process p of the plurality of processes;
the processor interpreting the received information to generate a plurality of values of one or more empirical metrics,
wherein the one or more empirical metrics comprise cycle times, handle times, response times, work-in-progress levels, and throughputs of the security operations center, and
wherein a first subset of the plurality of values comprises values of a first metric of the one or more empirical metrics that each quantify a prior performance of the first process by the security operations center; and
the processor deriving a value of a process-capability index C(p), wherein the value of C(p) quantifies, as a function of the first metric, the security operations center's ability to consistently meet quality standards when performing the first process p during the standard time period.

18. The computer system of claim 17,
wherein a target range of the first metric identifies, as a function of a business objective of the security operations center, a range of values of the first metric associated with an acceptable performance of the first process,
wherein a statistically derived range of the first metric identifies, as a statistical function of the first subset of the plurality of values, a range of values associated with the security operations center's performance of the first process during the standard time period, and
wherein the process-capability index C(p) is derived as a function of a ratio between the target range and the statistically derived range.

19. The computer system of claim 17, further comprising the processor identifying a process-proficiency index P(p) of the first metric that identifies the security operations center's time-averaged proficiency at performing the first process p, wherein the time-averaged proficiency comprises an average of a set of process-capability indices that each identify the security operations center's process-capability, as a function the first metric, to perform the first process p, and wherein the process-proficiency index P(p) characterizes the security operations center's performance over a period of time greater than the standard time period.

20. The computer system of claim 17, further comprising the processor identifying a CTW(p) ratio that characterizes the security operations center's target work-in-progress level when servicing service requests associated with the first process p, and wherein the target work-in-progress level is a function of a product of the security operations center's average cycle time when servicing service requests associated with the first process and the security operations center's average throughput when servicing service requests associated with the first process average.
